(19) United States
(12) Patent Application Publication
(10) Pub. No.: US 2007/0213997 A1
(43) Pub. Date: Sep. 13, 2007

(54) Method and apparatus for receiving product recall notices using broadcast channel

(76) Inventors: Jack Ivan J'maev, Chino, CA (US); Addison Brooke Jones, Yorba Linda, CA (US); Tzvetelin Petrov Petrov, Chino, CA (US)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 11/633,652

(22) Filed: Dec. 4, 2006

Related U.S. Application Data
(63) Continuation-in-part of application No. 10/615,412, filed on Jul. 7, 2003.
(63) Continuation-in-part of application No. 10/850,476, filed on May 19, 2004.
(60) Provisional application No. 60/394,980, filed on Jul. 9, 2002.
(60) Provisional application No. 60/471,976, filed on May 19, 2003.
(60) Provisional application No. 60/742,727, filed on Dec. 5, 2005.

(51) Int. Cl. G06Q 10/00; G06Q 30/00

(52) U.S. Cl. 705/1

(57) ABSTRACT

Disclosed are a method and various embodiments thereof for receiving a recall signal by determining a recall signaling frequency; receiving a recall signal on the determined recall signaling frequency; capturing a recall message from the recall signal when the recall message is targeted to at least one of a simple product, a product that is an assembly or a component in a product that is an assembly; notifying a user when a recall message is captured; storing a notice identifier included in the recall message in a substantially permanent manner, wherein the notice identifier is associated with a description of a specific recall campaign, said description being stored remotely from the product or itself being a textual description, a numeric description and alphanumeric description or an audible description.

### RELATED APPLICATIONS

The present application is a continuation-in-part of a parent U.S. patent application Ser. No. 10/615,412, filed on Ser. No. 07/07/2003 by Jack J'maev entitled “Method and Apparatus for Receiving a Product Notice” which is incorporated herein by reference in its entirety and which itself claims priority to U.S. provisional application Ser. No. 60/394,980 filed on Jul. 9, 2002 of the same title; this application is also a continuation-in-part of a parent U.S. patent application Ser. No. 10/850,476, filed on Ser. No. 05/19/2004 by Jack J'maev entitled “Method and Apparatus for Product-Centric Delivery of Product User Notices” which itself claims priority to U.S. provisional application Ser. No. 60/471,976 filed on May 19, 2003 of the same title; this application further claims priority to its provisional application of the same title Ser. No. 60/742,727 filed on Dec. 05, 2005.

### BACKGROUND

Applicant has described numerous embodiments for processing, disseminating and receiving product recall notices in the incorporated references and has discovered that it is difficult to support a national broadcasting system for the purposes of product recall. One of the most difficult challenges is that fact that radio frequency spectrum is difficult, if not impossible to acquire. Without such allocation of radio frequency spectrum, a national broadcasting mechanism for low-cost product recall messages would be difficult to establish.

### BRIEF DESCRIPTION OF THE DRAWINGS

Several alternative embodiments will hereinafter be described in conjunction with the appended drawings and figures, wherein like numerals denote like elements, and in which:

FIGS. 1 and 2 collectively form a flow diagram that depicts one example method for receiving product recall notices in a product using broadcast channels;

FIG. 3 is a flow diagram that depicts one example illustrative method for determining a recall signaling frequency by means of a scanning process;

FIG. 4 is a flow diagram that depicts an alternative example method for determining a recall signaling frequency using a list of recall signaling frequencies;

FIG. 5 is a flow diagram that depicts an alternative example method for receiving a recall signal in the form a plurality of digitally modulated carriers;

FIG. 6 is a flow diagram that depicts an alternative example method for receiving a recall signal in the form of a modulated subcarrier;

FIG. 7 as a flow diagram that depicts alternative example method for receiving a recall signal in the form an amplitude modulated signal wherein the amplitude modulated carrier is modulated either in frequency or phase;

FIG. 8 is a flow diagram that depicts alternative example method for providing a notification to a user;

FIG. 9 is a flow diagram that depicts alternative example method wherein the reception data of a product recall notice is recorded;

FIG. 10 is a flow diagram that depicts alternative example method wherein a user acknowledgment is received once a user is notified of a received recall message;

FIG. 11 is a flow diagram that depicts one example method wherein a time and/or date clock is updated according to a recall signal;

FIG. 12 as a flow diagram that depicts one example method wherein a recall signal is received in conjunction with media content;

FIG. 13 is a block diagram that depicts several example alternative embodiments of a product recall notice receiver;

FIG. 14 is a block diagram of one alternative example embodiment of the frequency determination unit that comprises a frequency slider;

FIG. 15 is a block diagram of an alternative example embodiment of a frequency determination unit that includes a frequency table;

FIG. 16 is a block diagram of an alternative example monument of a detector for receiving a plurality of frequencies within a prescribed band;

FIGS. 17 and 19 are a pictorial illustration of a subcarrier signal and the detector for receiving a subcarrier signal, respectively; and

FIGS. 18 and 19 are a pictorial illustration of an AM carrier that is modulated in frequency and/or phase and a detector for receiving data carried by an AM carrier that is modulated in this manner.

### DETAILED DESCRIPTION

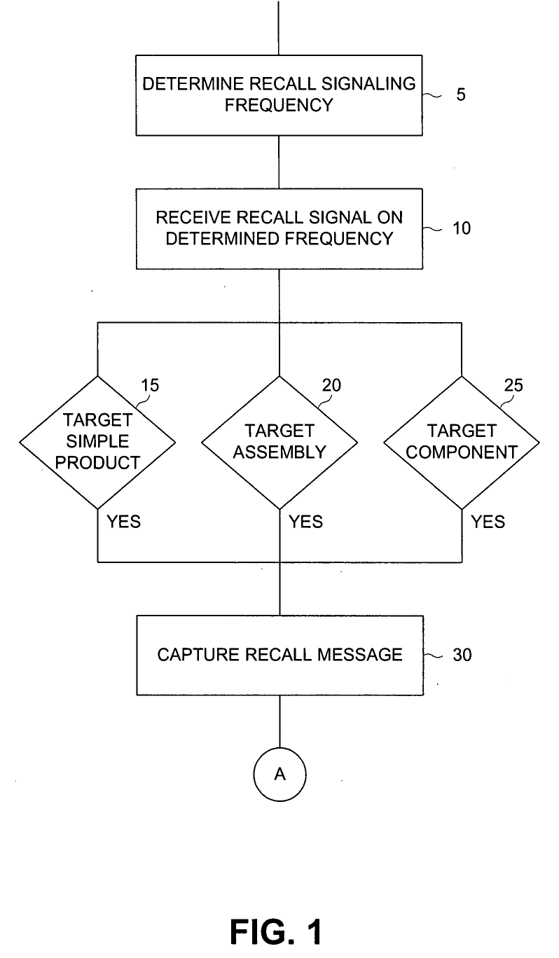

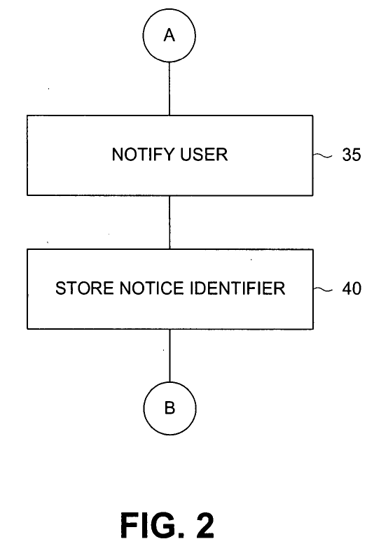

FIGS. 1 and 2 collectively form a flow diagram that depicts one example method for receiving product recall notices in a product using broadcast channels. According to this example method, a product recall notice is received in a product by means of a method comprising a step for determining a recall signaling frequency (step 5). The method further comprises receiving a recall signal on the determined recall signaling frequency (step 10). According to various alternative example methods, a recall signal includes a recall message that is targeted to at least one of a simple product (step 15), a product that is an assembly of various components (step 20) and a component included in a product that is an assembly (step 25).

When the recall messages is targeted to at least one of a simple product, a product that is an assembly or a component in a product that is an assembly the recall message is captured (step 30). It should further be understood that, according to one variation of the present method, the recall message includes a notice identifier. According to yet another variation of the present method, the notice identifier is stored (step 40) and the user is notified (step 35) when the recall message is captured. It should be appreciated that the notice identifier is used to identify a particular type of product recall notice.

According to one variation of the present method, the notice identifier comprises a textual, numeric and/or alphanumeric description. In yet another variation of the present method, the notice identifier is presented to a user as an indication of a particular type of product recall notice that is received by a product. In yet another variation of the present method, the notice identifier comprises an indicator that corresponds to a description of a product recall that is stored in a distal processing center.

It should be appreciated that these variations of a notice identifier are to be construed in accordance with the descriptions set forth in the copending patent application Ser. No. 10/615,412, filed on Ser. No. 07/07/2003 by Jack J'maev entitled “Method and Apparatus for Receiving a Product Notice” the specification and figures of which are incorporated herein by reference in their entirety. The specification and figures of copending U.S. patent application Ser. No. 10/850,476, filed on Ser. No. 05/19/2004 by Jack J'maev entitled “Method and Apparatus for Product-Centric Delivery of Product User Notices” are also incorporated herein in their entirety.

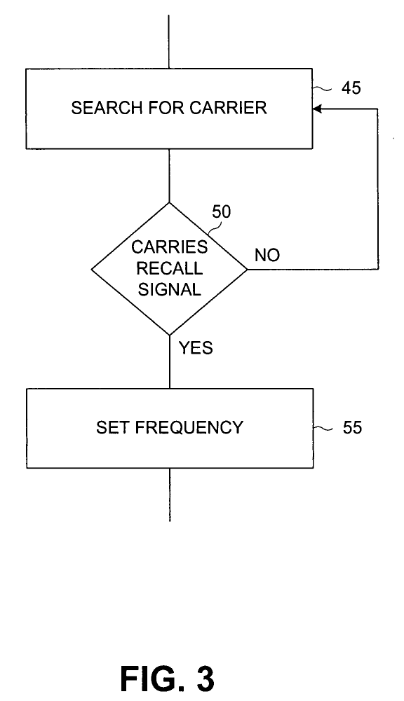

FIG. 3 is a flow diagram that depicts one example illustrative method for determining a recall signaling frequency by means of a scanning process. According to this example method, determining a recall signal frequency is accomplished by means of searching for a carrier within a pre-established frequency band (step 45). Once a carrier is found, the alternative example method further comprises a step for determining if the carrier signal is in fact carrying a recall signal (step 50). In the event that the carrier is actually carrying a recall signal, the frequency of the carrier signal is noted, i.e. that frequency is as the recall signaling frequency (step 55). In the event that the carrier is found not to be carrying a recall signal, a different carrier signal is then sought (step 45). Accordingly, one variation of the present method provides that this process be repeated until a carrier is found wherein such carrier is actually carrying a recall signal. In yet another variation of the present method, the process is discontinued once an entire pre-established frequency band is searched in order to discover a carrier that is carrying a recall signal.

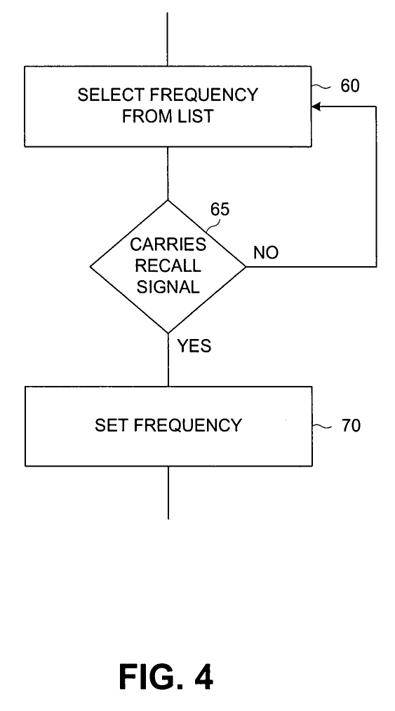

FIG. 4 is a flow diagram that depicts an alternative example method for determining a recall signaling frequency using a list of recall signaling frequencies. In contrast to an alternative method wherein a carrier signal is sought within a particular frequency band, this alternative example method provides for selecting a carrier signal frequency according to a list of recall signaling frequencies (step 60). According to this alternative example method, a list of recall signaling frequencies is typically, at least from the perspective of a receiver integrated into a product, is established on a priori basis. Once a particular frequency is selected, this alternative example method provides for determining if there's a carrier signal at the selected frequency and whether or not that carrier signal is actually carrying a recall signal (step 65). In the event that a recall signal is found on a carrier at the selected frequency, the frequency is noted and is used as a determined recall signaling frequency (step 70). In the event that a recall signal is not found a particular frequency as selected from the list of recall signaling frequencies, a different carrier signal frequency is selected from the list of recall signaling frequencies.

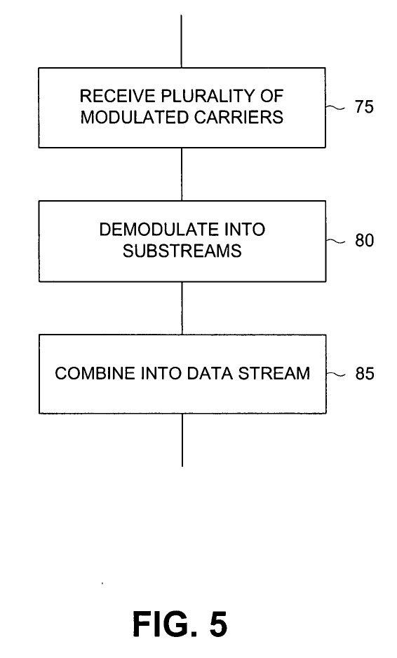

FIG. 5 is a flow diagram that depicts an alternative example method for receiving a recall signal in the form a plurality of digitally modulated carriers. According to this example alternative method, a recall signal on a determined recall signaling frequency is received by receiving a plurality of digitally modulated carriers within a prescribed band defined by the determined recall signaling frequency (step 75). Each of the modulated carriers within the modulated into data substreams (step 80). The data substreams are then combined into a composite datastream (step 85).

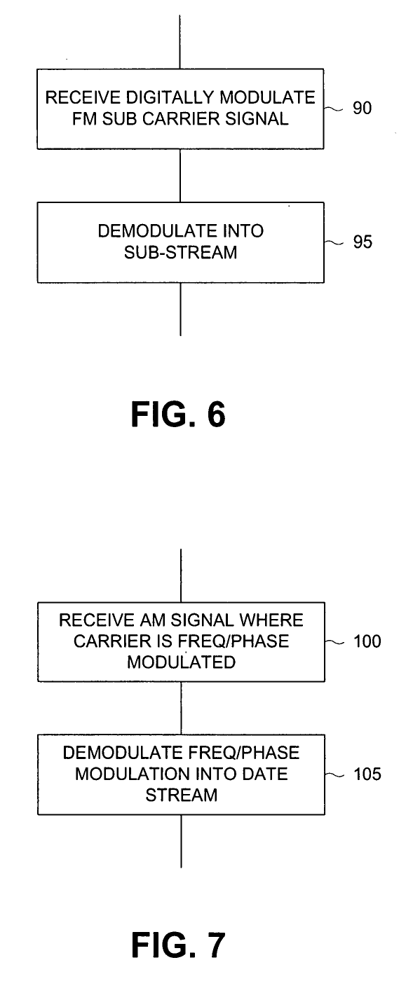

FIG. 6 is a flow diagram that depicts an alternative example method for receiving a recall signal in the form of a modulated subcarrier. According to this example method, a modulated subcarrier (step 90) associated with a frequency modulated (FM) signal is received and demodulated into a data stream or into a plurality of data sub streams (step 95). It should be appreciated that the modulated subcarrier, according to various alternative methods, is modulated either in phase and/or amplitude. One example modulation technique, which is not intended to limit the scope of claims appended hereto, comprises a frequency shift keying. Other modulation techniques may also be employed including, but not limited to amplitude modulation, frequency modulation, amplitude shift keying, minimum shift keying, binary phase shift keying, quadrature phase shift keying, quadrature amplitude modulation and others.

FIG. 7 as a flow diagram that depicts alternative example method for receiving a recall signal in the form an amplitude modulated signal wherein the amplitude modulated carrier is modulated either in frequency or phase. In this alternative example method, an amplitude modulated carrier is typically used to carry on audio program. The amplitude modulated carrier is itself modulated either in frequency or phase. For example, one alternative variation of the present method provides for modulating the frequency using minimum shift keying (MSK) modulation. It is just this type of a signal (i.e. an amplitude modulated signal where the carrier is also modulated either in frequency and/or phase) that is received (step 100) as a first step in receiving a recall signal on a determined recall signaling frequency. According to this variation of the present method, the frequency and/or phase modulation of the carrier that is carrying amplitude modulated information is demodulated into a datastream (step 105).

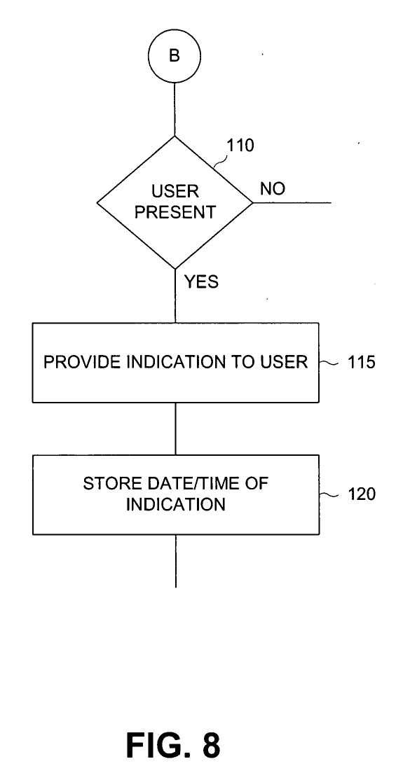

FIG. 8 is a flow diagram that depicts alternative example method for providing a notification to a user. According to this alternative example method, a user is notified by first determining when a user is present (step 110). In many situations, a product knows receiver integrated into a product is battery-powered and it is important to conserve battery power by not activating an indicator when a user is not present to see such indicator. Accordingly, an indication is provided to a user (step 115) when a user is actually present. According to this alternative example method, the date upon which an indication is provided to the user is also stored (step 120). It should be appreciated that come according to one variation of the present method, storage of the date upon which an indication is provided to user is accomplished in a substantially permanent manner.

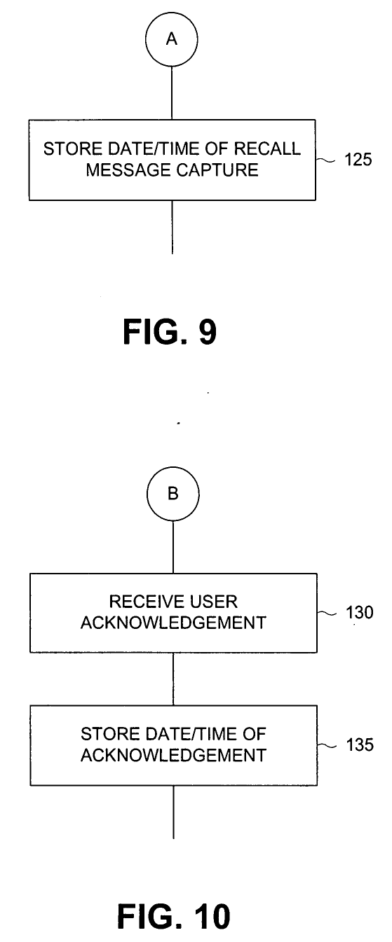

FIG. 9 is a flow diagram that depicts alternative example method wherein the reception data of a product recall notice is recorded. According to this example method, once a recall message has been captured the date of the capture of the recall message is stored (step 125). It should be appreciated that come according to one variation of the present method, storage of the date upon which a recall message is captured is a compost in a substantially permanent manner.

FIG. 10 is a flow diagram that depicts alternative example method wherein a user acknowledgment is received once a user is notified of a received recall message. According to this example variation of the present method, a user acknowledgment is received from a user (step 130) was the user is notified of a received product recall notice. The date and/or time of user acknowledgment is also stored (step 135). It should be appreciated that the date and/or time of a user acknowledgment, according to one variation of the present method, is accomplished in a substantially permanent manner.

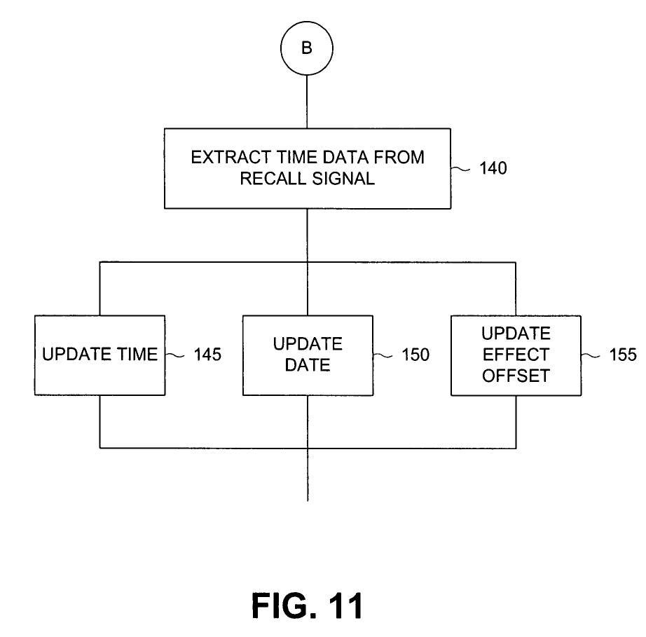

FIG. 11 is a flow diagram that depicts one example method wherein a time and/or date clock is updated according to a recall signal. According to this variation of the present method, time data is extracted from a received recall signal (step 140). It should be appreciated that the time data, according to various alternative variations of the present method, includes at least one of a time, a date and an offset from an epoch. Accordingly, this variation of the present method provides for updating a time maintained in a running clock (step 145) when the time data comprises a time value. Likewise, this variation of the present method provides for updating a date maintained in a running date clock (step 150) when the time data comprises a date value. When the time data comprises an offset from an epoch, an offset value maintained in a running offset clock is updated according to the extracted time data. Typically, the time data comprises a system time, which it self, according to various alternative example embodiments comprises at least one of a time, a date and an offset from an epoch. It should be appreciated that a time value, according to one variation of the present method, is received from an independent source. In other words, the time value is not extracted from a received recall signal but rather is received from a different source, e.g. a global positioning satellite (GPS) receiver, a direct broadcast satellite or from a correctional radio broadcast.

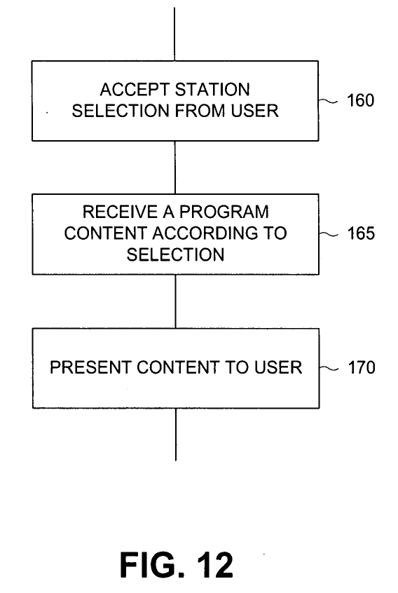

FIG. 12 as a flow diagram that depicts one example method wherein a recall signal is received in conjunction with media content. According to this alternative example method, a station selection is received from a user (step 160). Program content is then received according to the station selection (step 165). The program content is then presented to user 170). Accordingly, a single receiver assembly is able to receive a recall signal concurrently with program content. Typically, this requires two separate receivers integrated into a single apparatus. The first receiver is used to receive a recall signal while the second receiver is used to receive program content.

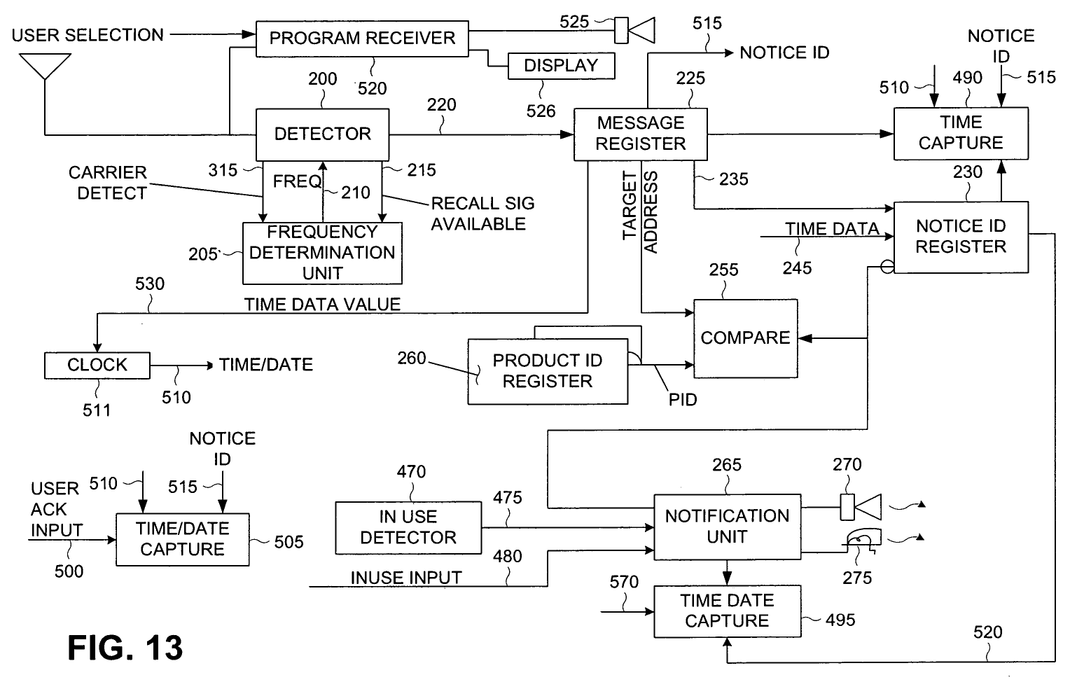

FIG. 13 is a block diagram that depicts several example alternative embodiments of a product recall notice receiver. According to one example embodiment, a product recall notice receiver includes a frequency determination unit 205, a detector 200, one or more product identification registers 260, a comparator 255, a notice type register 230 and a notification unit 265. In this example embodiment, the frequency determination unit 205 generates a frequency indicator 210. The frequency indicator 210 is used to direct the detector 200 to receive information any particular frequency (i.e. according to the frequency indicator 210). The one or more product identification registers 260 are used to store one or more product identifiers. It should be appreciated that a particular product identifier, according to one alternative example embodiment, corresponds to a simple product. And yet another embodiment, a product identifier corresponds to an assembly of simple products. And yet another alternative embodiment, a product identifier stored in the product identifier register 260 corresponds to a component included in an assembly of simple products. In operation, the detector 200 receives a recall signal according to the frequency indicator 210. The detector 200 generates a datastream 220 which is directed to the message register 225. The message register 225 organizes the datastream into a message. The comparator 255 generates a capture signal 250 when a target address 240 included in a message assembled in the message register 225 to substantially equivalent to a product identifier (PID) value stored in one or more of the product identifier register 260. In this example embodiment, the notice ID register 230 captures a notice identifier type indicator 235 included in a message assembled in the message register 225 when the capture signal 250 is active. It should be appreciated that according to one alternative example embodiment, the notice identifier type indicator comprises an indicator that corresponds to a description of a product recall that is stored in the distal processing center. And yet another alternative example embodiment, the notice identifier type indicator comprises a textual description of a product recall, a numeric description of a product recall, an alphanumeric description of a product recall or an audible description of a product recall.

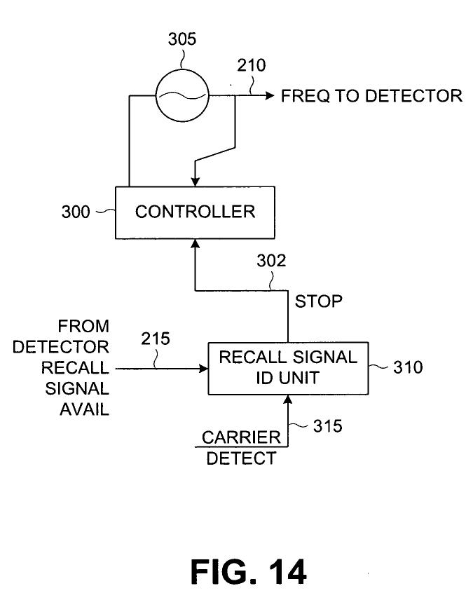

FIG. 14 is a block diagram of one alternative example embodiment of the frequency determination unit that comprises a frequency slider. According to this alternative example embodiment, a frequency determination unit 205 comprises a controllable oscillator 305 that generates a frequency 210 that is then directed to the detector 200. In operation, a controller 300 included in the frequency determination unit adjusts the frequency generated by the controllable oscillator and then waits for a prescribed amount of time before it again changes the frequency generated by the controllable oscillator 305. The controller 300 causes the controllable oscillator 305 to maintain a particular frequency when the controller 300 receives a stop signal 302 from a recall signal identification unit 310 included in this example embodiment of a frequency determination unit 205. The recall signal identification unit 310 receives a carrier detection signal 315 from the detector 200. The recall signal identification unit 300 and also receives a recall signal available signal 215 from the detector 200. According to this alternative example embodiment, the recall signal identification unit 310 will maintain an active stop signal 300 and to the controller 300 so long as the recall signal available signal 215 and the carrier deck signal 315, both of which are received from the detector 200, remain active. Otherwise, the controller 300 causes the controllable oscillator 305 to change the frequency 210 provided to the detector 200. It should be appreciated that the controller 300, according to one alternative example embodiment, receives a feedback so as to more precisely control the controllable oscillator 305 as the controllable oscillator 305 generates a frequency 210 which is then directed to the detector 200.

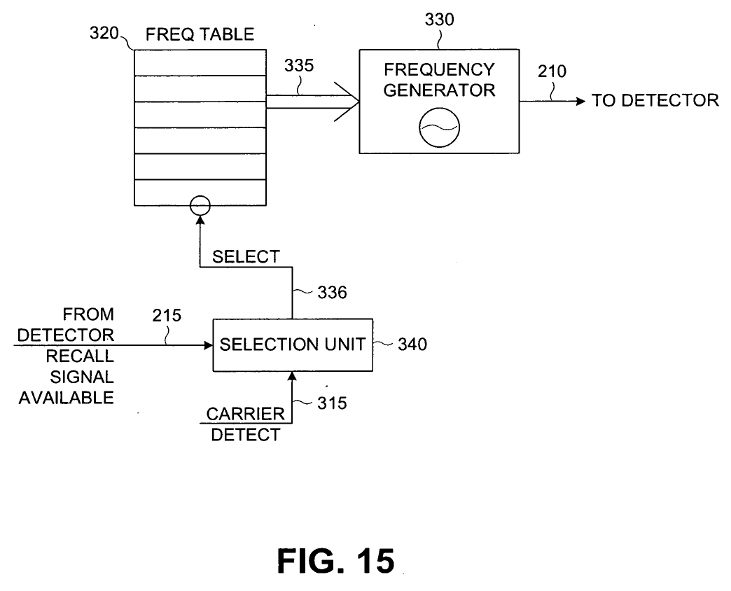

FIG. 15 is a block diagram of an alternative example embodiment of a frequency determination unit that includes a frequency table. According to this alternative example embodiment, the frequency determination unit 205 comprises a frequency table 320, a selection unit 340 and frequency generator 330. In operation, the selection unit 340 selects a frequency value 335 stored in the frequency table 320. The frequency value 335 is then presented to the frequency generator 330, which generates a frequency 210 according to the frequency value 335 provided by the frequency table 320. The selection unit 340 maintains a selection signal 336 to the frequency table 320 for a prescribed amount of time. In the event of the selection unit 340 does not receive a recall signal available signal 215 and a carrier deck signal 315 from the detector 200, the selection unit 340 will alter the selection signal 336 in order to select a different frequency value from the frequency table 320. In the event of the selection unit 340 receives a valid recall signal available signal 215 and the carrier detect signal 315 from the detector 200, it continues to maintain the selection signal 336 that it provides to the frequency table 320.

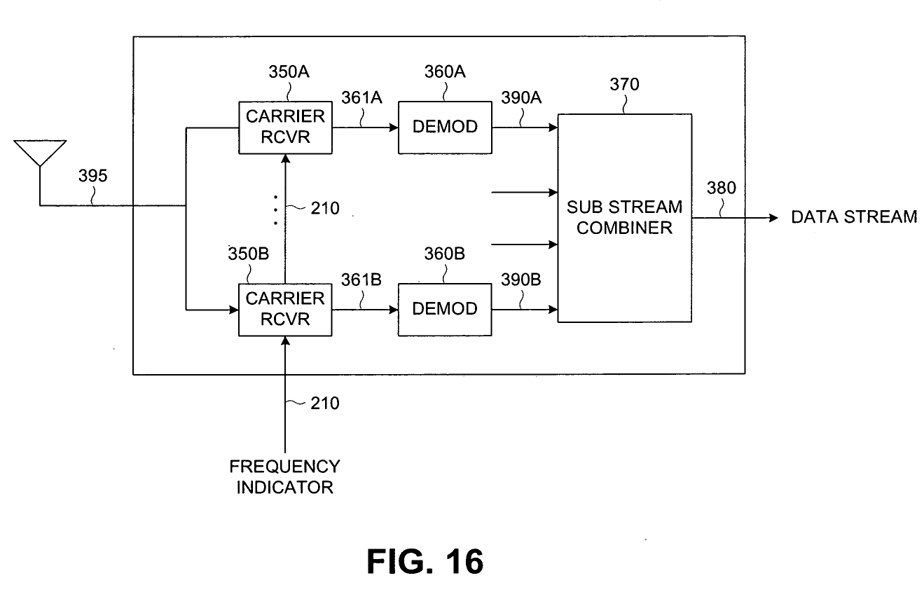

FIG. 16 is a block diagram of an alternative example monument of a detector for receiving a plurality of frequencies within a prescribed band. It should be appreciated that, according to this example embodiment, a detector 200 included in a product recall notice receiver comprises a plurality of the modulators (360A, 360B). Each such demodulator receives a modulated carrier (361A, 361B) from a corresponding carrier receiver (350A, 350B) which is also included in yet another alternative example embodiment of a detector 200. Each of the carrier receivers (350A, 350B) included in a detector 200 receives a frequency indicator 210 from the frequency determination unit 205. Each carrier receiver (350A, 350B) selects a modulated carrier from an antenna signal 395. It should be appreciated that a particular carrier receiver (350A, 350B) selects a modulated carrier according to the frequency indicator 210 received from the frequency determination unit 205.

A particular demodulator (360A, 360B) included in this alternative example embodiment of a detector 200 generates a digital data substream (390A, 390B) according to a modulated carrier (361A, 361B) received from a corresponding carrier receiver (350A, 350B) included in this alternative example embodiment of a detector 200. Accordingly, a plurality of data substreams (390A, 390B) generated by the plurality of demodulators (360A, 360B) are assembled into a composite data stream 380 by a substream combiner 370 also included in this example embodiment of a detector 200. The composite data stream 380 is then directed to the message register 225 included in this example alternative embodiment of a product recall notice receiver.

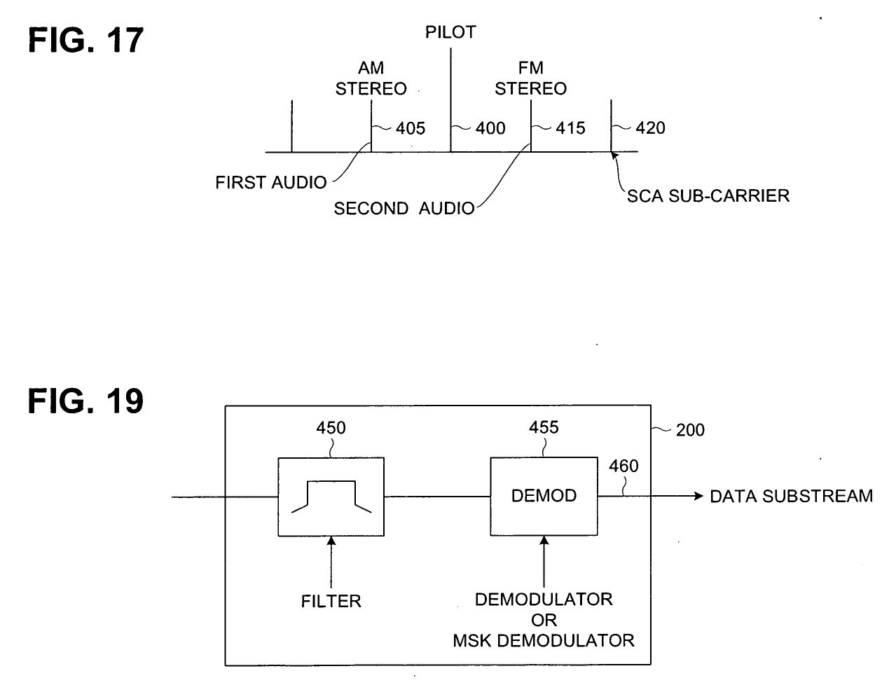

FIGS. 17 and 19 are a pictorial illustration of a subcarrier signal and the detector for receiving a subcarrier signal, respectively. It should be appreciated that, according to one example alternative embodiment, the product notice receiver claimed herein receives data by means of a subcarrier 420 associated with an FM radio channel. An FM radio channel typically includes a pilot tone (i.e. a carrier frequency) 400 and a first audio carrier signal 405. Where the FM radio channel is used to convey stereo program, the FM radio channel is also augmented with a second audio carrier 415. According to broadcast regulations better typically promulgated by a licensing authority, the FM radio channel can also include a subcarrier 420 as heretofore identified. It should be appreciated that such a subcarrier can be used to transmit data by a broadcaster. The broadcaster is authorized to broadcast data on such a subcarrier, at least in United States, under authority of the Subsidiary Communications Authority (SCA) statutes promulgated by the Federal Communications Commission (FCC).

In those example embodiment where a product recall notice receiver receive is a product recall notice by means of a SCA subcarrier 420 associated with an FM radio channel, the detector 200 includes a filter 415 for selecting the SCA subcarrier 420 from the FM radio channel. The selected SCA subcarrier is then demodulated using a demodulator 455 also included in this example embodiment of a detector 200. The demodulator 455 generates a data stream (or substream) 460 which is then directed to the message register 225 included in the product recall notice receiver.

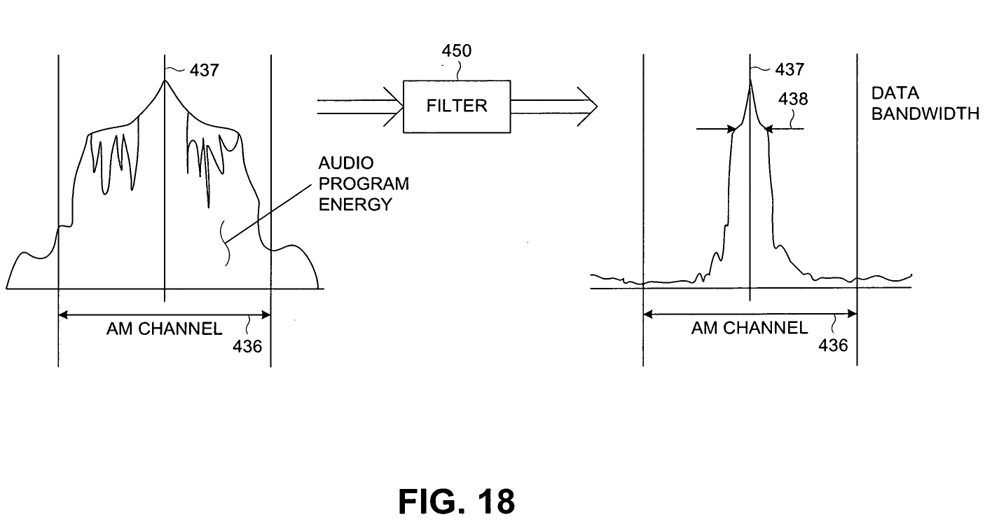

FIGS. 18 and 19 are a pictorial illustration of an AM carrier that is modulated in frequency and/or phase and a detector for receiving data carried by an AM carrier that is modulated in this manner. It should be appreciated that an AM radio station generates a carrier signal, which is depicted as a peak 437 in a spectral plot of an AM channel 436. The AM channel 436 itself includes other energy surrounding the peak 437. This other energy represents modulation of the carrier signal 437 by an audio program. It should be appreciated that the carrier signal 437, according to this example embodiment, is modulated in frequency and/or phase by a digital data stream. In one example embodiment, the data rate of the digital data stream used to modulate either the frequency and/or phase of the carrier signal is extremely slow (e.g. 10 or 12 bps or less). Depending on the bandwidth required for a particular modulation technique, the data rate is selected so as to minimize and/or avoid audio artifacts that could otherwise be detected by a listener in joining the audio program carried within the AM channel 436. For example, in one in embodiment the carrier is modulated using a minimum shift keying (MSK) modulation technique. Typically, MSK modulation requires approximately 1.5 times the data rate in bandwidth. Hence, a data rate of 7.5 bps will require less than 12 hertz in bandwidth. At 12 hertz, any audio artifacts would typically be below the lowest frequency perceived by human ears.

Accordingly, one alternative example embodiment of the product recall notice receiver includes a detector 200 that includes a filter 450 then narrowly selects only the peak 437 and excludes the energy in the AM channel 436 that represents the audio program. As such, the filter 450 passes a limited data bandwidth 438 commensurate with the modulation technique used to convey a low data rate digital data stream in the background of a standard AM broadcast transmission.

It should be appreciated that, according to this example embodiment, the detector 200 includes a demodulator 455 then generates a data stream 460 according to phase and/or frequency variations exhibited by the narrowly selected carrier 437. The data stream 460 is then directed to the message register 225. It should likewise be appreciated that, according to one example alternative embodiment, the demodulator 455 comprises and MSK demodulator. It should also be appreciated that, according to various alternative example embodiment, the demodulator comprises at least one of a frequency modulation demodulator, an amplitude shift keying demodulator, a binary phase shift keying demodulator, a quadrature phase shift keying demodulator, and a quadrature amplitude modulation demodulator.

FIG. 13 further illustrates that, according to one example alternative embodiment, a product recall notice receiver further includes an in-use input 475. The in-use input 475 enables the notification unit 265 to receive an indication as to whether or not a product is in use. In this example embodiment, the notification unit 265 provides an indication to a user when the in-use indication input 475 is active. And in yet another alternative example embodiment, the product notice receiver further includes an in use detector 470 as described in the incorporated reference. In yet another alternative example embodiment, the message register provides a notice identifier 515 that is included in a captured recall message and is used to identify a particular type of recall message. It should be appreciated that the notice identifier 515 includes at least one of identifier that corresponds to a description of a particular recall where the description is stored in a distal memory and a description of a particular recall. When a particular recall description is received, the description comprises at least one of a numeric description, a textual description, an alphanumeric description, a visual description and an audible description. In the case where a visual description is received, the visual description is received in the form of a digital image file. Examples of digital English files include, but are not necessarily limited to a moving image file and a still image file. A moving image file, according to alternative embodiments, included are not limited to MPEG1, MPEG2, MPEG3 and MPEG4 files. A still image file, according to alternative embodiment, include but are not limited to TIFF files, JPEG files, raster image files and vector image files. In the case where an audible description is received, the audible description, according to one example embodiment, is received in the form of a digital audio file (e.g. a“.WAV” file). It should be appreciated that any suitable representation of an audio description and any suitable representation of a visual description may be used in the claims appended hereto are not intended to be limited to any examples heretofore presented.

FIG. 13 also further illustrates that, according to yet another illustrative alternative embodiment, a product recall notice receiver further includes a message captured time register 490. The message captured time register 490 stores a time value 510 when the message register 225 captures a recall message from the data stream 220 receive from the detector 200. In one alternative example embodiment, the message captured time register 490 also stores the notice identifier 515 provided by the message register 225. In yet another alternative example embodiment, a product notice receiver further comprises a user acknowledgement input 500. The user acknowledgment input 500 is used to receive a user acknowledgment from a user. Such a user acknowledgment is typically provided by the user in response to an indication provided by the notification unit 265. When the user acknowledgment input 500 is active, this example embodiment of a product notice receiver stores a time value 510 in a user acknowledgment time register 505 that is also included in the product recall notice receiver of this illustrative alternative embodiment. In yet another alternative example embodiment, the user acknowledgment time register 505 also stores the notice identifier 515 (provided by the message register 225) when the user acknowledgment input 500 is active.

FIG. 13 further illustrates that, according to yet another alternative example embodiment, a product recall notice receiver further includes a time clock 511. The time clock 511, according to this example embodiment, receives a time value 530 from the message register 225. It should be appreciated that the message register 225 receives a time value when the detector 200 provides a data stream 220 that represents a time beacon message as described in the incorporated reference. In all of the example embodiments presented heretofore, the time value comprises at least one of a time of day, a date, a system time and an offset from an epoch (e.g. seconds since Jan. 1, 2000). It should further be appreciated that all of these example forms of time values are presented herein to illustrate and are not intended to limit the claims appended hereto.

FIG. 13 also illustrates that, according to yet another alternative illustrative embodiment, a product recall notice receiver further includes a program receiver 520. Accordingly, the program receiver 520 receives a media program (e.g. an audio program and/or a video program) and directs the media program to a presentation device. In one alternative example embodiment, the presentation device comprises an audio transducer 525 (e.g. a speaker). In yet another alternative example by men, the presentation device comprises a video display 526. As such, the program receiver 520 receives a user selection 530 and selects a particular program channel according to the user selection 530.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for receiving product recall notices in a product using broadcast channels comprising:
determining a recall signaling frequency;
receiving a recall signal on the determined recall signaling frequency;
capturing a recall message from the recall signal when the recall message is targeted to at least one of a simple product, a product that is an assembly or a component in a product that is an assembly;
notifying a user when a recall message is captured;
storing a notice identifier included in the recall message in a substantially permanent manner, wherein the notice identifier is associated with a description of a specific recall campaign, said description being stored remotely from the product or itself comprises a textual description, a numeric description and alphanumeric description or an audible description.

2. The method of claim 1 wherein determining a recall signaling frequency comprises:
searching for a carrier signal within a pre-established frequency band;
determining if the carrier signal is carrying a recall signal;
noting a frequency for the carrier signal when the carrier signal is carrying a recall signal; and
searching for a different carrier signal when the carrier signal is not carrying a recall signal.

3. The method of claim 1 wherein determining a recall signaling frequency comprises:
selecting a frequency according to a list of recall signaling frequencies;
determining if a carrier signal at the selected frequency is carrying a recall signal;
noting a frequency for the carrier signal when the carrier signal is carrying a recall signal; and
selecting a different carrier signal frequency from the list of recall signaling frequencies when a carrier signal at the selected frequency is not carrying a recall signal.

4. The method of claim 1 wherein receiving a recall signal on the determined recall signaling frequency comprises:
receiving a plurality of digitally modulated carriers within a prescribed band defined by the determined recall signaling frequency; and
demodulating each digitally modulated carrier into a data sub-stream.

5. The method of claim 1 wherein receiving a recall signal on the determined recall signaling frequency comprises:
receiving a modulated sub-carrier of a frequency modulated signal; and
demodulating the modulated sub-carrier into a data stream.

6. The method of claim 1 wherein receiving a recall signal on the determined recall signaling frequency comprises:
receiving an amplitude modulated carrier that is also frequency and/or phase modulated; and
demodulating the frequency and/or phase modulation of the carrier into a data stream.

7. The method of claim 1 wherein notifying a user comprises:
determining when a user is present;
providing an indication to the user; and
storing the date on which the indication is provided to the user.

8. The method of claim 1 further comprising storing the date when a recall message is captured.

9. The method of claim 1 further comprising:
receiving a user acknowledgement in response to the notification; and
storing the date when the user acknowledgement is received.

10. The method of claim 1 further comprising:
extracting a system time from the recall signal; and
updating a clock according to the extracted system time, wherein the system time includes at least one of a time, a date, and an offset from an epoch.

11. The method of claim 1 further comprising:
accepting a station selection from a user;
receiving a media content according to the station selection; and
presenting the media content to the user.

12. A product notice receiver comprising:
frequency determination unit that generates a frequency indicator;
detector for receiving a product recall notice signal according to the frequency indicator;
one or more product identification registers that stores one or more product identifiers;
comparator that generates a capture signal when a target address included in the product recall notice signal matches at least one of the product identifiers stored in the one or more receiver identification registers;
notice register that captures a notice type identifier included in the product recall notice signal when it receives a capture signal and wherein the notice type identifier corresponds to a description of a recall campaign that is stored distally from the product notice receiver or comprises at least one of a textual description, a numeric description, an alphanumeric description or an audible description; and
notification unit that provides an indication when the capture signal is active.

13. The product notice receiver of claim 12 wherein the frequency determination unit comprises:
frequency slider that generates a succession of frequency indicators within a given frequency band until it receives a stop signal; and
recall signal identification unit that generates a stop signal to the frequency slider when a signal received from the detector is carrying a recall signal.

14. The product notice receiver of claim 12 wherein the frequency determination unit comprises:
frequency table that stores one or more frequency indicators;
selection unit that successively selects a different location in the frequency table until it receives a stop signal; and
recall signal identification unit that generates a stop signal to the selection unit when a signal received from the detector is carrying a recall signal.

15. The product notice receiver of claim 12 wherein the detector comprises:
a plurality of demodulators set to a plurality of frequencies within a prescribed band identified by the frequency indicator that generate a corresponding plurality of data sub-streams according to the individual carries they process; and
data stream combiner that combines the plurality of sub-streams into a data stream.

16. The product notice receiver of claim 12 wherein the detector comprises:
Sub-carrier demodulator that demodulates a sub-carrier into one or more digital data streams.

17. The product notice receiver of claim 12 wherein the detector comprises:
Frequency-phase demodulator that receives an amplitude modulated signal wherein the signal is also modulated in phase and/or frequency and generates a data stream according to the phase and/or frequency modulation.

18. The product notice receiver of claim 12 wherein the detector comprises:
Minimum shift keying demodulator that receives an amplitude modulated signal wherein the signal is also modulated using MSK and generates a data stream by demodulating the MSK component of the amplitude modulated signal.

19. The product notice receiver of claim 12 further comprising:
in-use input that receives an in-use indication and wherein the notification unit provides an indication to a user when the in-use indication is received.

20. The product notice receiver of claim 12 further comprising:
message captured time register that records at least one of a date, a time, a system time and an offset from an epoch when the message register captures a recall message from a data stream received from the detector.

21. The product notice receiver of claim 12 further comprising:
user acknowledgement input; and
user acknowledgement time register that records at least one of a date, a time, a system time and an offset from an epoch when the user acknowledgement input senses an input signal.

22. The product notice receiver of claim 12 further comprising a time clock that maintains a time value including at least one of a time, a date, a system time and an offset from an epoch and wherein the message register provides a time value to the time clock as a means of setting the time value to be maintained.

23. The product notice receiver of claim 12 further comprising program receiver that accepts a station selection from a user, receives a program according to the station selection and presents the received program to the user.
